(19) United States
(12) Patent Application Publication
(10) Pub. No.: US 2012/0065458 A1
(43) Pub. Date: Mar. 15, 2012

(54) IMPLANTABLE DEVICE WITH COMMUNICATION MEANS

(75) Inventor: Jeroen Jacob Arnold Tol, Eindhoven (NL)

(73) Assignee: Koninklijke Philips Electronics N.V., Eindhoven (NL)

(21) Appl. No.: 13/320,614

(22) PCT Filed: May 4, 2010
(86) PCT No.: PCT/IB2010/051943

§ 371 Date: Nov. 15, 2011

(30) Foreign Application Priority Data
May 15, 2009 (EP) 09160437.1

(51) Int. Cl. H04R 25/00

(52) U.S. Cl. 600/25

(57) ABSTRACT

The invention relates to an implantable device, e.g. a Deep Brain Stimulation device (10), and to a method for communicating information from such an implantable device (10) to its carrier. The communication is achieved by the emission of sound from a transmitter (16) into the body material surrounding the implantable device (10), wherein said sound yields signals that are audible for the carrier of the implantable device (10). In particular, the emitted sound may comprise audible frequencies or modulated ultrasonic frequencies. According to a further development, the implantable device (10) may additionally comprise a receiver (16) for receiving sound from the surrounding body material, wherein said received sound may encode information for the implantable device (10).

### FIELD OF THE INVENTION

The invention relates to an implantable device with a control unit and to a method for communicating information from an implantable device to its carrier.

### BACKGROUND OF THE INVENTION

Implantable devices are used in a variety of diagnostic and therapeutic medical applications. One important example of implantable devices are pacemakers for the heart. Moreover, Deep Brain Stimulation (DBS) devices are increasingly used in recent years to treat neural disorders like Parkinson disease. Communication with such implantable devices is often realized via radio frequency (RF) signals, which requires an external receiver/transmitter to be operated by the patient.

### SUMMARY OF THE INVENTION

Based on this background it that was an object of the present invention to provide means for a simple and reliable communication of information from an implantable device to its carrier.

This object is achieved by an implantable device according to claim 1 and a method according to claim 15. Preferred embodiments are disclosed in the dependent claims.

According to its first aspect, the invention relates to an implantable device, i.e. to a device that is at least partially disposed within the body of an animal or human carrier for a prolonged time. Typically, implantable devices will permanently and completely be located inside the body of their carrier. The implantable device of the present invention comprises the following components:
a) A control unit which, as its name indicates, exerts some control function. This control function comprises at least the transmitter control to be explained in the following. Usually, it comprises also the control of the functionality the implantable device is intended for, for example the control of the application of electrical stimulation pulses to some body tissue.
b) A transmitter that is controlled by the aforementioned control unit with respect to the selective emission of sound into the surrounding body material (when being implanted), wherein said sound yields (directly or indirectly) signals that are audible for the carrier of the implantable device.

The invention further relates to a method for communicating information from an implantable device to its (human or animal) carrier, said method comprising the emission of sound from a transmitter into the body material surrounding the implantable device, wherein said sound yields signals that are audible for the carrier of the implantable device.

The implantable device and the method defined above have the advantage that they allow a direct communication of information from an implantable device to its carrier, because sound is used that yield signals which are audible for the carrier. This is advantageous with respect to handling comfort, because the user does not need a particular external apparatus for receiving signals from the implant. Moreover, it is advantageous with respect to safety, because the implant can convey information to its carrier whenever and wherever this is necessary and without the risk that the information is lost (e.g. because the carrier does not have an external receiver with him/her or because of some malfunction of an external receiver).

In the following, further developments of the invention will be described that relate both to the implantable device and the method described above.

The sound that is emitted by the transmitter preferably encodes some information about the status of the body in which the device is implanted, for instance about the detection of an unusual neural activity in the brain that might require a change of therapy. Additionally or alternatively, the sound may encode some information about the status of the implantable device itself, for instance about the conditions of power supply of the device, reminding for example the user that a battery recharge is necessary.

According to a preferred embodiment, the implantable device is a Deep Brain Stimulation (DBS) device. Due to its positioning in the head of a patient, such a DBS device is particularly suited for the transmission of sound to the ear.

The transmitter may preferably be designed to be implanted in acoustic contact with some bone, particularly with the skull of the carrier of the implantable device (e.g. in case of a DBS device). Acoustically contacting bone allows the transmitter to exploit the favorable acoustic transmission characteristics of the hard bone material.

With respect to its temporal course, the emitted sound will have some frequency spectrum describing its Fourier components. According to a preferred embodiment of the invention, the emitted sound may comprise or completely consist of audible frequencies, i.e. frequencies in the range of about 16 Hz to about 20 kHz. These frequency components of the sound hence directly constitute signals that are audible for the carrier of the implantable device.

According to another embodiment, the emitted sound may comprise or completely consist of modulations of an ultrasonic carrier-sound, i.e. of a carrier-sound with a frequency between about 20 kHz and 1 GHz. Ultrasonic frequencies are too high to be directly audible. The emitted sound will therefore not be noticed by persons near the carrier of the implantable device. However, due to their modulation, the ultrasonic frequencies can have some audio content that is demodulated by nonlinearities within the ear and by the brain's perception of audible frequencies (cf. U.S. Pat. No. 6,631,197 B1). Hence only the carrier of the implantable device will notice (and comprehend) the message conveyed by the implant.

When the emitted sound shall represent some information about the state of the implanted device or the body, the ongoing transmission of the sound may simply indicate that this state prevails, while silence indicates the absence of said state. Thus a sound might for example continuously be emitted when battery charge is below a predetermined level. In a more elaborate approach, the sound transmission may use some code to represent information, wherein said code may comprise the use of different frequencies of the emitted sound and/or the use of temporal patterns of the emitted sound. For example, different levels of battery charge might be encoded by different audible frequencies of the emitted sound or, alternatively, by sound pulses of different duration. Having at least two different “characters” (besides a simple “off”) available—for example low/high tones, or short/long pulses—it is in principle possible to encode any information of interest, for example via some binary code or a Morse code.

The emission of sound by the transmitter may optionally be restricted to predetermined time slots in order to prevent such an emission at times when it might be inappropriate. Moreover, such a restriction to particular time slots may have the advantage that the carrier of the implantable device can be prepared to the (possible) occurrence of a sound transmission, thus reducing the risk that a message might be missed.

According to a further development of the invention, the implantable device may additionally comprise a receiver for receiving sound from the surrounding body material. Said receiver may favorably be realized by the same hardware as the transmitter, as often only the operational mode of a transducer needs to be inverted to make a transmitter (converting e.g. electrical energy into sound) work as a receiver (converting sound into electrical energy).

The receiver may for example be used to detect sound originating from physiological activities, for example from heart beat. In a preferred embodiment, the reception of sound is however used to convey information to the implantable device. To this end, the control unit of the implantable device may be adapted to detect predefined codes in the received sound. Typically, detection of such predefined codes will initiate some suitable response or reaction of the implantable device, for example a change in its operational mode (e.g. the assumption of a low-power mode or of certain therapy settings).

The aforementioned predefined codes may preferably correspond to sound patterns that originate from a knocking on bone and/or from coughing of the carrier of the implantable device. These sound patterns can readily be generated by the carrier of an implant, thus allowing some communication with the implant without additional technical devices like a remote control. The carrier will hence have control over his/her implant at any time and in any place.

Additionally or alternatively, the predefined codes mentioned above may correspond to sound patterns that originate from another implantable device. In this case two or more implanted devices can exchange information acoustically.

In order to prevent that noise may erroneously be interpreted as a meaningful code by the control unit, the detection of predefined codes in received sound may be limited to predefined time slots. The control unit might for instance be listening for the reception of predefined codes at every full hour (or according to any other time schedule that is appropriate).

The aforementioned time slots may optionally depend on operational conditions or on the state of the implantable device. In particular, the time slots may comprise a time interval after the emission of sound by the transmitter. In this case the control unit will be listening for a “reply” from the user each time the implant has transmitted some information to the user.

### BRIEF DESCRIPTION OF THE DRAWINGS

These and other aspects of the invention will be apparent from and elucidated with reference to the embodiment(s) described hereinafter. These embodiments will be described by way of example with the help of the accompanying drawings in which:

FIG. 1 schematically shows a patient with a DBS device according to the present invention;

FIG. 2 schematically shows a sectional view of the DBS device of FIG. 1;

FIG. 3 schematically shows a sectional view of a modification of the DBS device.

Like reference numbers in the Figures refer to identical or similar components.

### DESCRIPTION OF PREFERRED EMBODIMENTS

In the following, the invention will be described with respect to Deep Brain Stimulation (DBS), though it can be used in many other applications, too.

The beneficial therapeutic effects of the application of small electric stimuli to central nervous tissue have been discovered by Benabid and co-workers (Grenoble) in the late 1980's. Applying the so-called high-frequency electrical stimulation (130 Hz, −3 V, 60 μs, typical stimulation parameters) to thalamic structures could relieve both Parkinson's disease (PD) patients and Essential Tremor (ET) patients from their tremor. In later years, other targets for deep brain stimulation (DBS) have been identified (e.g. internal segment of the globus pallidus, GPi, and subthalamic nucleus, STN) that resulted in marked improvements of quality of life of PD patients. Moreover, the use of DBS for other neurological disorders like epilepsy and depression is being examined.

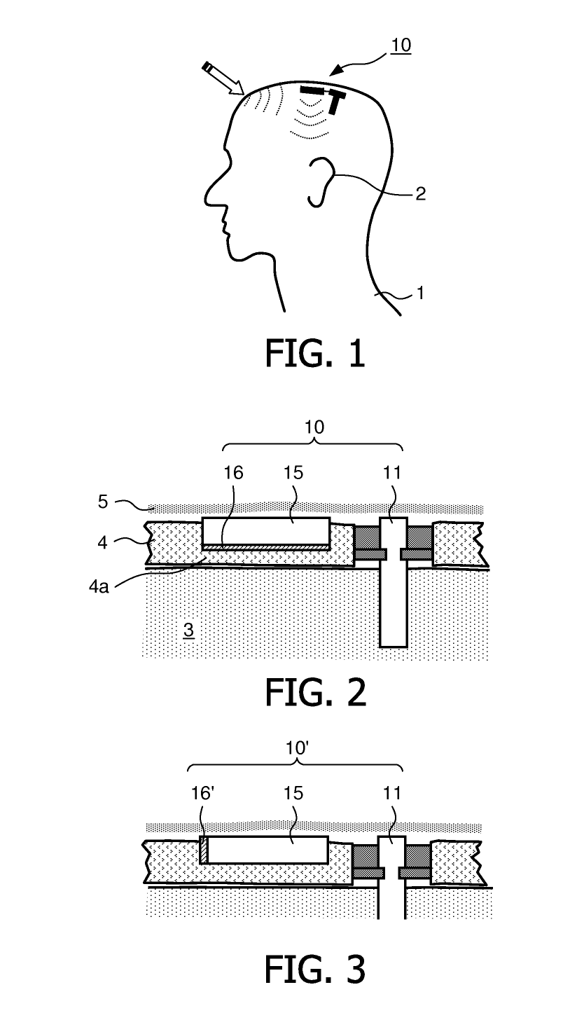

FIG. 1 schematically shows a DBS device 10 according to the present invention which is implanted in the head of a patient 1. During the operation of such a device, it can be advantageous to inform the patient 1 of an unforeseen or critical situation. Although a deep brain stimulator can be equipped with a means (e.g. RF) to communicate with an external device (e.g. a remote control) to inform a patient of the status of the implanted brain pace maker, it imposes on the patient the burden to always carry this external device if it is also used to warn or remind the patient of a critical or unforeseen operating condition of the brain pace maker.

It is therefore proposed here to relay a warning or reminder signal sonically. Audible signals will then relieve the patient of the burden to always have an external device with her/him just to be able to receive a warning or reminder signal, which, for normal operation according to the given instructions, should not occur often. Moreover, it may enable the patient to communicate with the implant with sounds without the need for an external communication device (e.g. remote control). Thus the invention improves user friendliness and safe (via audible warnings) or intended (via audible reminders) usage of an implant.

FIG. 2 shows the DBS device 10 that is designed according to the above principles in more detail in a schematic sectional view. The device 10 comprises a probe 11 that is implanted in a burr-hole in the skull 4 and that extends with stimulation electrodes (not shown) into the neural tissue of the brain 3. The probe 11 is electrically connected to a control unit 15 that is also implanted into the skull 4, resting on the tabula interna 4a. The implanted units 11, 15 are covered by the skin 5. As usual, the control unit 15 will comprise a pulse generator for generating electrical pulses that are supplied to the stimulation electrodes of the probe 11 and the necessary control logic and software to control the generator. The details of such stimulation procedures are known to a person skilled in the art.

In the embodiment of the DBS device 10 shown in FIG. 2, the control unit 15 further comprises at (a part of) its bottom side an acoustic transmitter 16 that is in acoustic (and preferably also mechanical) contact with the tabula interna 4a and that is controlled by the control unit. The transmitter 16 may be realized by an ultrasonic transducer, for example a cMUT (cf. Ergun, S. A., Goksen G. Yaralioglu, G. G.; Khuri-Yakub T. B.: “Capacitive Micromachined Ultrasonic Transducers: Theory and Technology”, Journal of Aerospace Engineering, April 2003, Volume 16, Issue 2, pp. 76-84) or a piezo loudspeaker, in good acoustic contact with the skull 4.

Warnings or reminders that shall be emitted by the transmitter 16 may be encoded with different sounds or sound patterns either in the audible frequency range or modulated on a higher frequency ultrasonic carrier. Audio modulated on an ultrasonic carrier has the advantage that ultrasonic carriers are inaudible for others, while the modulated ultrasonic carrier, conveyed via the skull as communication channel to the ears 2 of the patient, leads to audible sounds. The audio content of the ultrasonic carrier is demodulated by the non-linearities within the ear itself and the brain's perception of audible frequencies (cf. U.S. Pat. No. 6,631,197 B1).

FIG. 3 shows a modified DBS device 10′. The difference with respect to FIG. 2 is that the transmitter 16′ (e.g. a cMUT ultrasound transducer) is embedded in (part of) the outer perimeter of the control unit 15.

The ultrasonic transducers 16, 16′ can also be applied as a receiver (microphone), and therefore, the patient can communicate with the implant by self generated sounds without the need for an external communication device. If a patient has two implanted DBS devices, it would also be possible to set up a low bit rate data communication link between the two implants (ultra-)sonically. Two examples how a (bidirectional) communication facility between a patient and an implant can advantageously be applied in the case of a DBS device mounted in the skull are discussed next.

The first example relates to the management of the battery (not shown) that supplies the DBS device 10 (or 10′) with energy. Battery lifetime is strongly dependent on the level of discharge. The deeper the discharge, the earlier the battery of a DBS device needs to be replaced by a surgical procedure. The other way around, if the battery is only partly discharged, for example only 25% between recharging sessions, the battery lifetime increases significantly.

It is therefore in the interest of the patient to stick to a regular recharging schedule, while deep discharge should be avoided. To this end, the patient can be reminded that the battery should be recharged by an audible beep released by the transmitter 16. This beep can be modulated on an ultrasonic carrier to completely prevent that others can hear this beep too. A different beep or beep pattern may be applied to warn that the battery enters the deeply discharged regime.

The limits for “recharge” and “deeply discharged”, the chosen sounds, their repetition frequency and allowable time slots during the day at which the transmitter is active can all be set by the physician in the hospital.

If it is not possible for the patient to do a recharge, it would be favorable if the patient could turn off the reminder or warning beeps. This may be accomplished if the DBS device 10 is established with a receiver for sound, wherein said receiver may simply be realized by the transducer 16 that also operates as transmitter. A few gentle knocks on the head may then for example serve as sonic signals from the patient to the implant. The knocking sound can be recorded by the transducer 16, in particular after it has entered a “listening” mode for a limited amount of time after beeps have been given. The implant can then react for instance by delaying the next reminder or warning beeps. The “knocking codes” and their effect can be programmed by the physician too.

If a patient has two implants, different tones could be chosen or different patterns to let the patient know which implant needs a recharge.

Many variations of the above design are possible. For example, “coughing codes” instead of “knocking codes” could be applied. These are less striking, and maybe the patient is more at ease using such a coding scheme in public environments.

A second example of the communication facility relates to therapy selection. The bidirectional audio communication (“knocking codes”) described above would also make it possible for a patient to change the applied therapy to a different (e.g. less-effective but also less power hungry) pre-programmed therapy setting if, for example, the battery is about to enter the “deeply discharged” regime or if the patient's condition worsens.

Moreover, a closed-loop deep brain stimulator could ask for confirmation if it records brain activity which might indicate that a different therapy needs to be given.

As described, the invention can favorably be applied to deep brain stimulators mounted in the skull. Moreover, other implants (fixated or not fixated to a bone) which need to warn, remind or need a patient's consent or feedback can benefit from the invention if the (bidirectional) communication should even be possible in situations where the patient does not have an external communication unit at her/his disposal.

Finally it is pointed out that in the present application the term “comprising” does not exclude other elements or steps, that “a” or “an” does not exclude a plurality, and that a single processor or other unit may fulfill the functions of several means. The invention resides in each and every novel characteristic feature and each and every combination of characteristic features. Moreover, reference signs in the claims shall not be construed as limiting their scope.

1. An implantable device (10, 10′), comprising:
a) a control unit (15);
b) a transmitter (16, 16′) that is controlled by the control unit (15) to selectively emit sounds into surrounding body material, wherein said sound yields signals that are audible for the carrier (1) of the implantable device.

2. The implantable device (10, 10′) according to claim 1,
characterized in that the emitted sound codes information about the status of the implantable device (10, 10′) and/or the body it is implanted in, particularly about the power supply conditions of the implantable device.

3. The implantable device (10, 10′) according to claim 1,
characterized in that the implantable device is a Deep Brain Stimulation device (10, 10′).

4. The implantable device (10, 10′) according to claim 1,
characterized in that the transmitter (16, 16′) is adapted to be implanted in acoustic contact with bone, particularly with the skull (4) of the carrier (1) of the implantable device (10, 10′).

5. The implantable device (10, 10′) according to claim 1,
characterized in that the emitted sound comprises audible frequencies.

6. The implantable device (10, 10′) according to claim 1,
characterized in that the emitted sound comprises modulated ultrasonic frequencies.

7. The implantable device (10, 10′) or the method according to claim 2,
characterized in that the code of the emitted sound comprises the use of different frequencies and/or of temporal patterns.

8. The implantable device (10, 10′) according to claim 1,
characterized in that the emission of sound by the transmitter (16, 16′) is restricted to predetermined time slots.

9. The implantable device (10, 10′) according to claim 1,
characterized in that the implantable device comprises a receiver (16, 16′) for receiving sound from surrounding body material.

10. The implantable device (10, 10′) according to claim 9,
characterized in that the control unit (15) is adapted to detect predefined codes in the received sound.

11. The implantable device (10, 10′) according to claim 10,
characterized in that the predefined codes correspond to sound patterns originating from knocking on bone and/or from coughing.

12. The implantable device (10, 10′) according to claim 10,
characterized in that the predefined codes correspond to sound that originates from another implantable device.

13. The implantable device (10, 10′) or the method according to claim 10,
characterized in that the detection is limited to predefined time slots.

14. The implantable device (10, 10′) according to claim 13,
characterized in that the time slots comprise a time interval after the emission of sound by the transmitter (16, 16′).

15. A method for communicating information from an implantable device (10, 10′) to its carrier (1), comprising the emission of sound from a transmitter (16, 16′) into body material surrounding the implantable device, wherein said sound yields signals that are audible for the carrier (1) of the implantable device.
